(19) United States
(12) Patent Application Publication
(10) Pub. No.: US 2011/0308066 A1
(43) Pub. Date: Dec. 22, 2011

(54) Simultaneous Integral Milling Operation Machine

(75) Inventors: Robert Schroeder, Machesney Park, IL (US); William E. O'Connor, Belvidere, IL (US); Dennis L. Oldenburg, Beloit, WI (US)

(73) Assignee: PACIFIC BEARING COMPANY, Rockford, IL (US)

(21) Appl. No.: 13/172,441

(22) Filed: Jun. 29, 2011

Related U.S. Application Data
(63) Continuation of application No. PCT/US2009/069905, filed on Dec. 31, 2009.
(60) Provisional application No. 61/141,950, filed on Dec. 31, 2008.

(51) Int. Cl. B23P 23/06; B23P 13/00

(52) U.S. Cl. 29/558; 29/561

(57) ABSTRACT

A machining apparatus and method of machining a work piece are provided. The method generally includes machining a plurality of independent surfaces of the work piece as the work piece travels along a work path and through a plurality of machining stations in a single pass. The machining apparatus includes a frame and first and second machining stations mounted to the frame. Each machining station is configured to form an independent surface in a work piece passed through the machining apparatus. The machining apparatus also includes a feed arrangement for feeding the work piece through the apparatus along a feed path and relative to the first and second machining stations and the frame while machining is performed on the work piece.

### CROSS-REFERENCE TO RELATED PATENT APPLICATIONS

This patent application is a continuation of co-pending PCT Patent Application No. PCT/US2009/069905, filed Dec. 31, 2009, and claims the benefit of U.S. Provisional Patent Application No. 61/141,950, filed Dec. 31, 2008, the entire teachings and disclosures of which are incorporated herein by reference thereto.

### FIELD OF THE INVENTION

This invention generally relates to machining apparatuses and methods of machining a work piece.

### BACKGROUND OF THE INVENTION

Manufacturing of parts and devices includes numerous types of processes for forming parts or objects into desired shapes. One particular manufacturing process includes machining a work piece to a desired shape. Machining may include, but is not limited to, grinding, cutting, lapping, sanding, milling and polishing the work piece to have the desired shape or profile. To increase output, machining of work pieces has become automated. However, to have accurately machined shapes with high tolerances, the work piece must be accurately located relative to the machining station performing work on the work piece.

For example, one device, the linear guide, has a carriage that glides upon a rail. In many applications, the carriage must accurately glide upon the rail. As a result, the rail must possesses a high degree of dimensional accuracy. Unfortunately, certain types of rails are extruded elongated parts and are prone to the mechanical deflections often associated with extruded elongated parts. For example, extruded rails are often times prone to bowing, twisting, and/or warping deflections after extrusion.

Therefore, it is not uncommon to first take an initial cut upon an unmachined surface of a work piece, the rail in the case of a linear guide, to establish a datum or qualified surface that the work piece will later rest upon during later machining operations to other portions of the work piece. Other machined dimensions are thereafter indicated from the datum or qualified surface. In many cases, a single datum surface is not enough, and therefore a work piece must be repositioned several times to complete the manufacture of the work piece. To reposition the work piece, machining operations are paused, the fixturing of the work piece is often changed, and the work piece is then fixtured in a different orientation prior to any further machining.

Several problems arise by stopping to refixture a work piece. First, many geometrical dimensions, e.g. flatness, parallelism, and perpendicularity, require a high degree of dimensionally accuracy, often referred to as “tight tolerances.” By stopping to refixture, i.e. “breaking set up,” the original datum surface that previously machined dimensions indicate from is lost. As a result, any future machined surfaces indicating from the original datum surface after breaking set up and refixturing will possess an inherent margin of error relative to the previously machined surfaces. In many cases, e.g. parallelism between a previously machined surface and a later machined surface machined after breaking set up, the margin of error can fall outside of the predefined tolerance level. Such a problem is exacerbated in tight tolerance scenarios.

Second, breaking set up results in a loss of value adding machining time. The more time a machine spends in set up, the less time the machine has to manufacture parts. A loss of machining time is viewed as a lost opportunity by manufacturers. As a result, a reduction in set up time is often equated to an increase in profitability.

Third, breaking set up to refixture a work piece in a different configuration often necessitates additional fixtures that results in the use of multiple fixtures to manufacture a work piece. Multiple fixtures drives up the cost to manufacture the work piece by increasing the overhead for a given work piece. Additionally, fixtures are also typically catalogued and maintained in a manufacturers inventory. Cataloguing and maintaining fixtures in inventory decreases storage space in a manufacturing facility that could otherwise be used for sellable inventory.

The present invention relates improvements over the current state of the art for machining work pieces.

### BRIEF SUMMARY OF THE INVENTION

The embodiments described herein provide new and improve machining apparatuses and methods of machining independent surfaces into a work piece. These embodiments provide new and improved machining apparatuses and methods of machining independent surfaces into a work piece while a work piece makes a single pass along a feed path. These new and improved embodiments also reduce machining time for the work piece. Additionally, the embodiments described herein increase the dimensional accuracy between the plurality of different independent surfaces of the work piece, ultimately resulting in better machining tolerance levels, i.e. tighter tolerances. Further, the new and improved embodiments reduce the number of set-ups for positioning the work piece to a single set-up to reduce the machining time and cost associated with the work piece. As a result, various ones of the independent surfaces may have a high degree of dimensional accuracy, e.g. parallelism, relative to one another. To wit, parallelism of within 0.001 inch per linear foot or better between various ones of the independent surfaces is achievable.

In one particular embodiment, a method for machining a work piece is provided. The method comprises the steps of machining a first independent surface into the work piece along a length of the work piece using a first machining station and machining a second independent surface into the work piece along the length of the work piece using a second machining station. Further embodiments include machining additional independent surfaces into the work piece including, but not limited to, third, fourth, fifth and sixth independent surfaces using third, fourth, fifth and sixth machining stations.

The work piece may be fed along a feed path relative to the machining stations while maintaining the machining stations stationary relative to a frame supporting the machining stations, rather than moving the machining station relative to the work piece and/or frame. In a preferred implementation, all of the independent surfaces formed in the work piece are formed by passing the work piece along the feed path a single time. In such an implementation, each of the independent surfaces formed during the machining process are formed by a separate machining station.

In some implementations, the various steps of machining the independent surfaces can occur, at least partially, simultaneously on the work piece. Further, various ones of the steps of machining the independent surfaces can be performed at a same location along the feed path or various ones of the steps of machining may be performed at different locations along the feed path.

Certain embodiments may also include automatically switching between preconfigured machining arrangements such that different work piece beginning and end profiles can be machined. Switching between machining arrangements can include adjusting a position of a machining station in directions non-parallel to the feed path as well as angularly relative to the feed path. However, switching between machining arrangements may also include adjusting the relative position of machining stations along the feed path.

In some implementations, the steps of forming various ones of the independent surfaces includes forming one or more qualified surfaces and other ones of the steps of forming independent surfaces are located off of that qualified surface and tolerances are maintain between the qualified surface and the surfaces that are located off of the qualified surface. When independent surfaces are located off of qualified surfaces, the work piece may be supported in a direction transverse to the length of the feed path with the qualified surface. The support may be provided at the location where the step of machining the independent surface is located off of the qualified surface.

Methods may include further comprising the steps of machining a third independent surface into the work piece along the length of the work piece using a third machining station and machining a fourth independent surface into the work piece along the length of the work piece using a fourth machining station. The step of machining the first independent surface defines a first qualified surface and the step of machining the third independent surface defines a second qualified surface and the fourth independent surface is toleranced relative to the second qualified surface. A preferred implementation of this method includes the step of supporting the work piece in a first direction transverse to the length of the feed path with the first qualified surface at the location where the step of machining the second independent surface is performed on the work piece and further comprising the step of supporting the work piece in a second direction transverse to the length of the feed path with the second qualified surface at the location where the step of machining the fourth independent surface is performed on the work piece.

Various ones of the machining stations may perform, but are not limited to performing, any of the following machining processes cutting, milling, grinding, sanding, polishing and super polishing. Further, various ones of the steps of machining the independent surfaces forms surfaces that may be planar or contoured. Further, the work piece may be a base rail for a guide rail.

In yet another embodiment, a machining apparatus for machining a plurality of independent surfaces in a work piece is provided. The machining apparatus including a frame, first and second machining stations and a feed arrangement. The first machining station is for machining a first independent surface into the work piece. The first machining station is mounted to the frame. The second machining station is for machining a second independent surface into the work piece. The second machining station is mounted to the frame. The feed arrangement feeds the work piece through the apparatus along a feed path and relative to the first and second machining stations and the frame while machining is performed on the work piece.

Alternative embodiments may have additional machining stations including, but not limited to, a third, fourth, fifth and sixth machining stations mounted to the frame for machining third, fourth, fifth and sixth independent surfaces into the work piece, respectively.

Preferably, the plurality of machining stations are moveable relative to the frame to adjust positions thereof relative to the feed path, the positions of the machining stations being fixable relative to the frame such that the machining stations are in a fixed position during machining The machining stations may be moveable relative to the frame such that the first and second machining stations are angularly positionable relative to the feed path. The machining stations may be moveable relative to the frame such that the first and second machining stations are linearly positionable relative to the feed path along a direction that is perpendicular to the feed path.

The machining stations may be positioned at various axial positions along the feed path. Particularly, in some embodiments, the first machining station is positioned upstream from the second machining station along the feed path. In other embodiments, the first and second machining stations are positioned at a same position along the feed path.

The machining stations may include a drive mechanism, a machining head and a positioning system. The drive mechanism operably couples to the machining head to drive the machining head to perform a machining operation on the work piece. The positioning system mounts, at least, the machining head to the frame and adjusts the position of the machining head relative to the frame. The positioning systems may be fixable such that the machining heads are stationary relative to the frame during machining and while the work piece is fed linearly along the feed path through the machining apparatus.

In one embodiment the feed arrangement includes an upstream portion upstream along the feed path from the first machining station and a downstream portion downstream along the feed path from the first machining station. The downstream portion includes a first support arrangement. The first support arrangement supporting the work piece via the first independent surface after the work piece passes through and is machined by the first machining arrangement. More preferably, the first support arrangement includes a first guide upon which the first independent surface rides. Even more preferably, the first support arrangement further including a biasing mechanism for biasing the work piece toward the first guide and the first independent surface into the first guide.

Embodiments may further include a second downstream portion downstream from the second machining station. The second downstream portion includes a second support arrangement. The second support arrangement supports the work piece via the second independent surface after the work piece passes through and is machined by the second machining arrangement.

The machining apparatus may further include an electronic controller for controlling operations of the first and second machining stations. In one embodiment, the electronic controller is preprogrammed with a plurality of different selectable machining station set-ups for machining different profiles into the work piece, such as different shapes or different sizes. In one more particular embodiment, the difference between at least two of the different machining station set-ups is a position of at least one of the first and second machining stations relative to the feed path. The electronic controller operably controls the position of the first and second machining stations in accordance with the selected one of the selectable machining station set-ups. In such an arrangement, the positioning of the machining stations, and particularly the machining head, is performed by automatic actuators. These actuators may be electric, pneumatic, hydraulic or otherwise for positioning the structures.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric simplified illustration of a machining apparatus according to one embodiment of the present invention;

FIG. 2 is an isometric enlarged more detailed partial isometric illustration of a portion of the machining apparatus of FIG. 1;

FIG. 3 is an end view illustration of the machining apparatus of FIG. 1;

FIG. 4 is a simplified example of a work piece prior to machining using embodiments of the present invention;

FIG. 5 is an end view illustration of the work piece during a first phase of machining using embodiments of the present invention;

FIGS. 6A and 6B are end view illustrations of the work piece during a second phase of machining using embodiments of the present invention;

FIG. 7 is an end view illustration of the work piece during a third phase of machining using embodiments of the present invention; and

FIG. 8 is an end view of illustration of the work piece after machining using embodiments of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

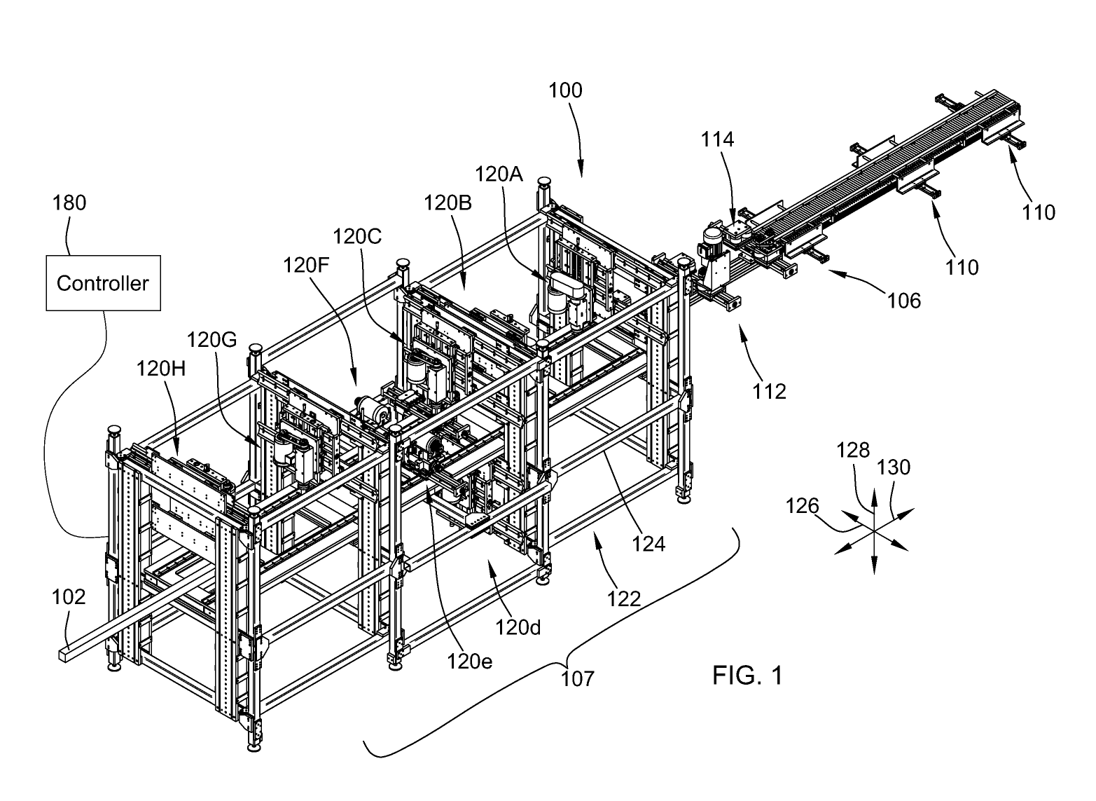

FIG. 1 illustrates a simplified representation of an embodiment of a machining apparatus 100 according to the teachings of the present invention. The machining apparatus 100 is used to machine multiple independent surfaces of a work piece 102 as the work piece 102 passes in a feed direction illustrated as arrow 130 along a feed path 104 and through the machining apparatus 100. The machining apparatus achieves this functionality through the use of multiple machining stations 120A-H.

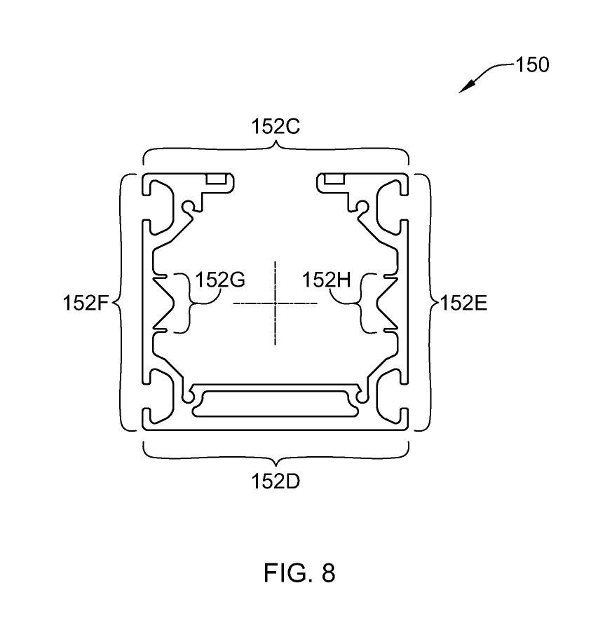

As will be more fully explained below, the machining stations 120A-H are arranged along a linear feed path 104. The work piece 102 is fed along the feed path 104 by a feed arrangement 106. Various ones of the machining stations 120A-H simultaneously machine various ones of independent surfaces 150A-F of the work piece 102 (see FIG. 8). It will be recognized that the ordering of the machining stations 120A-H is not limited to the illustrated embodiment of FIG. 1. Indeed, other orderings of the machining stations 120A-H are possible, dependent upon a given application. Additionally, the machining stations 120A-H are arranged serially along the feed path in the illustrated embodiment. However, in other embodiments, the machining stations 120A-H may be arranged along a non linear, e.g. curved, feed path.

The machining apparatus 100 includes a feed arrangement for feeding the work piece 102 through the machining apparatus 100. In the illustrated embodiment, only an upstream section 106 of the feed arrangement is illustrated. This upstream section 106 forces work pieces 102 into the machining section of the machining apparatus 100. However, in other embodiments, the feed arrangement may also include a downstream section that is similar to or identical to upstream section 106. However, this downstream section will be positioned at the opposite end of the machining apparatus 100 as the upstream section and will act to draw a work piece 102 from the machining apparatus, and more particularly from the region of the machining apparatus 100 where machining operations will occur.

The sections of the feed arrangement that are upstream and downstream from the locations where machining operations occur provide support mechanisms for supporting and guiding motion of the work piece 102 as the work piece 102 enters, passes through, and exits the portion of the machining apparatus in which machining operations occur, illustrated generally at 107.

To provide both lateral and vertical support for the work piece 102, the feed arrangement includes support arrangements, for example, vices 110. The vices 110 can be adjusted to change a path way through which the work piece 102 may be fed along the feed path 104. The jaws of the vices 110 can be open or closed depending on the size of the work piece 102 and location of the vices 110 along the feed path 104. Further, the vertical position can be adjusted to accommodate different upstream or downstream machining operations to assist in properly positioning the work piece prior to or after a machining operation is to be or has been performed.

Some representative vices are illustrated in U.S. Provisional Patent Application Ser. No. 61/074,075, filed Jun. 19, 2008, entitled “Modular Adjustable Vise,” the teachings and disclosure of which are incorporated herein in their entireties by reference thereto. The jaws of the disclosed vice in U.S. Provisional Patent Application Ser. No. 61/074,075 may incorporate guide rollers as discussed above.

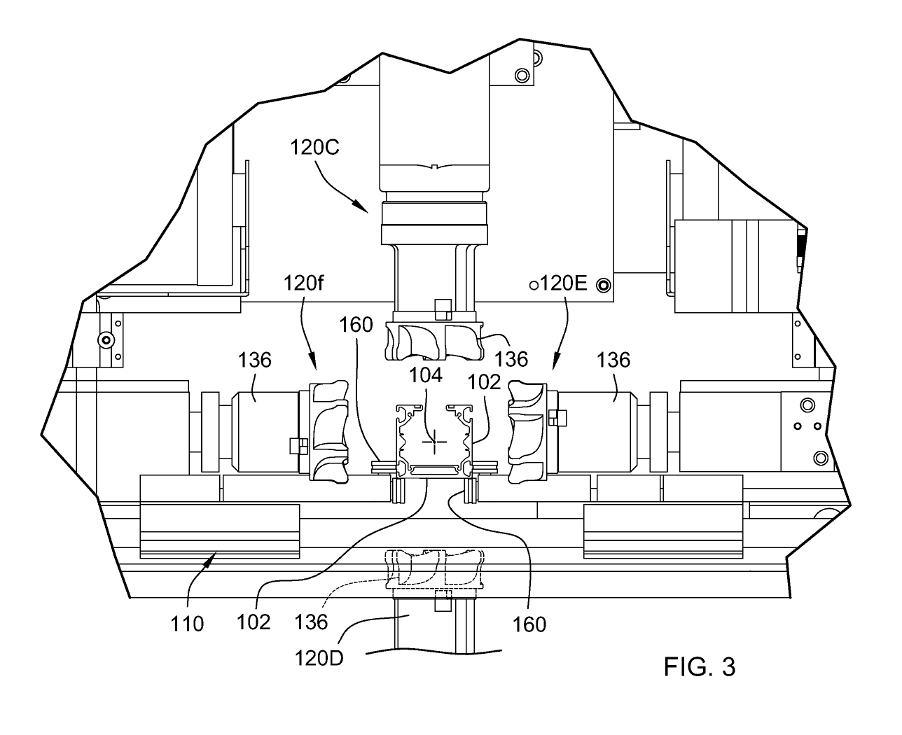

With reference to FIG. 3, the jaws of the vices 110 may include guide rollers 160 that are arranged to provide rolling vertical support as well as rolling lateral support so as to reduce friction on the work piece as it passes through the machining apparatus 100. Alternatively, low friction pads can be used on the jaws to help reduce friction. As illustrated, the guide rollers 160 support the sides of the work piece 102, as well as an underside thereof. Furthermore, the feed arrangement can also incorporate guide rollers 160 along the entirety, or alternatively along a portion of, the feed path 104. In such an embodiment, the guide rollers 160 are incorporated into the vices 110 as well as independent thereof.

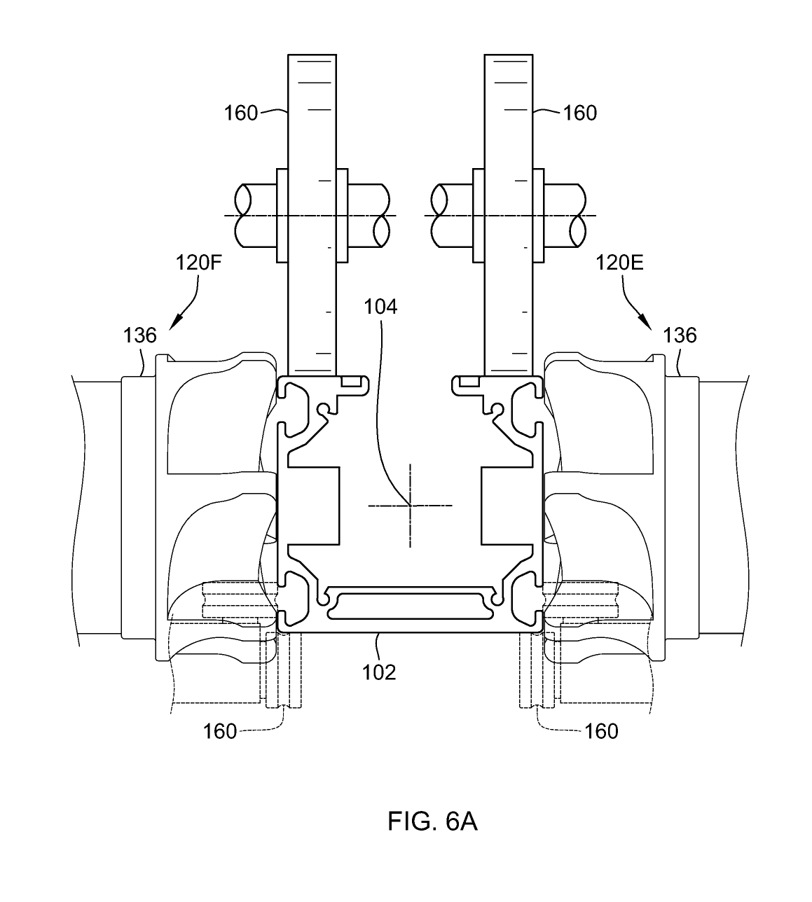

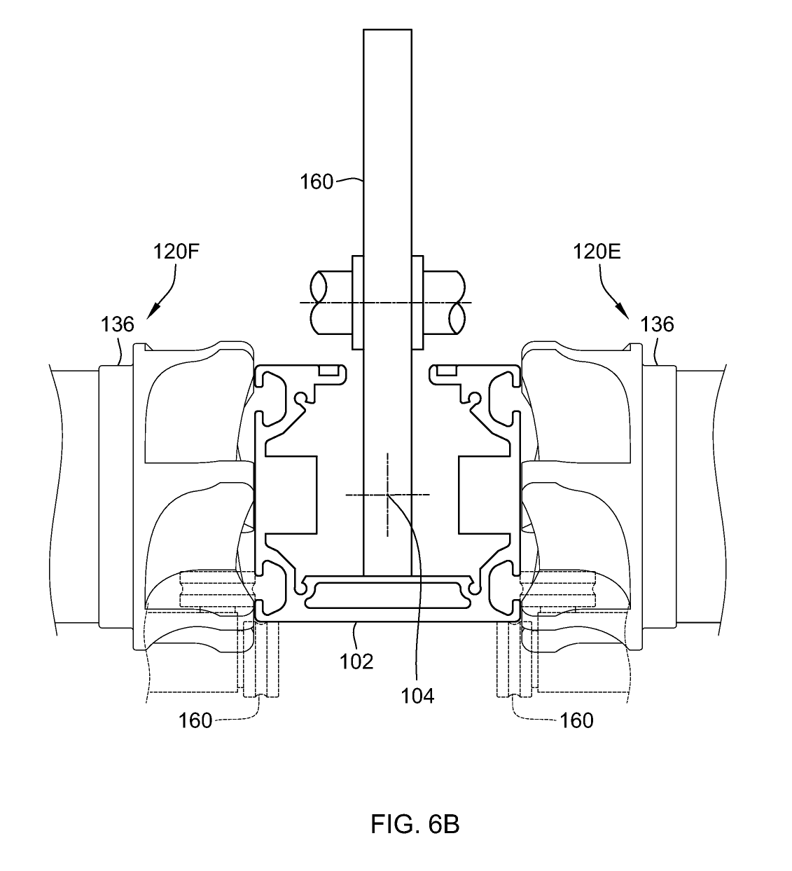

The feed arrangement 110 further includes guide rollers 160 in the illustrated configurations of FIGS. 6A and 6B. As illustrated in FIG. 6A, in one embodiment, the guide rollers 160 contact an upper surface of the work piece 102. The guide rollers 160 may contact an unfinished or a finished surface of the work piece 102.

Similarly, and with reference to FIG. 6B, a single guide roller 160 can contact an interior surface 151 of the work piece 102. Such a configuration may be used, for example, if the top surface of the work piece 102 has an opening large enough to make the use of dual guide rollers 160 such as that illustrated in FIG. 6A undesirable due to minimal contact surface area offered by the upper surface.

These vices 110 or support arrangements may also be interposed between various machining stations to provide secure and accurate positioning of the work piece 102, 150 in order to maintain high dimensional accuracy. Put another way, the support arrangements, e.g. vices 110 and guide rollers 160, can be positioned between the machining stations 120A-H or provided integrally therewith.

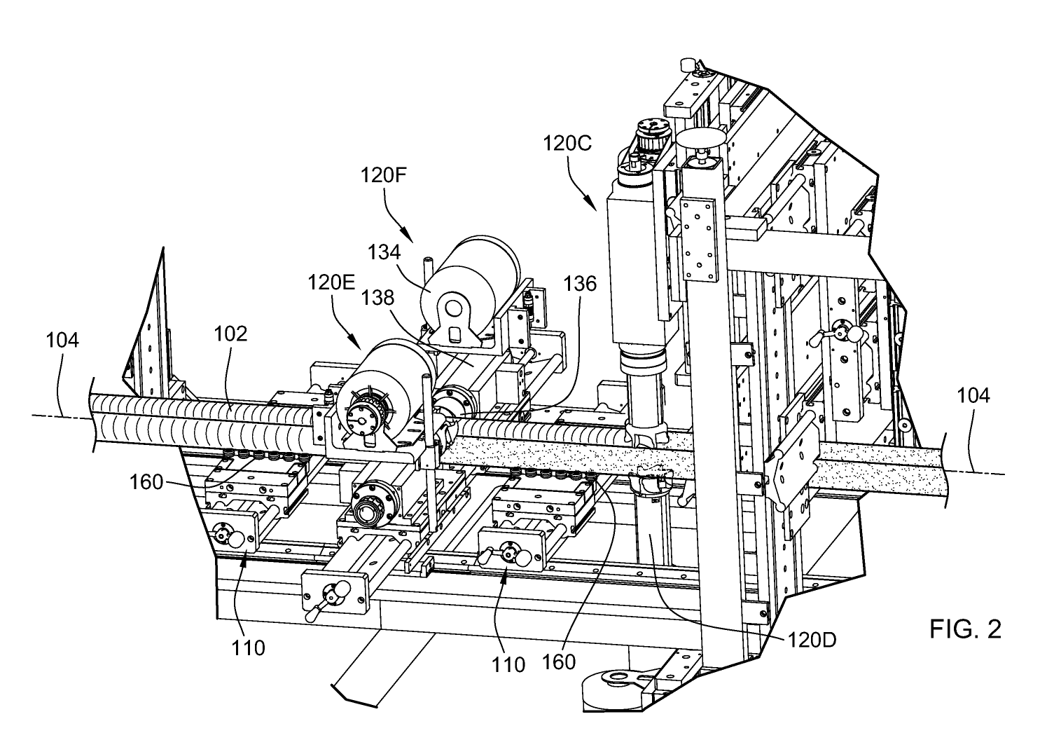

Turning now to FIGS. 1 and 2, the feed arrangement also includes drive mechanisms 112 that, depending on their location relative to the work piece 102, push or pull the work piece 102 through the machining apparatus 100 and past various machining stations. The representative drive mechanisms 112 include guide wheels 114 (also referred to as drive wheels) that press on lateral sides of the work piece 102 to drive the work piece 102 through the machining apparatus 100. The spacing between the guide wheels 114 is adjustable so as to adjust the normal force applied to the work piece 102 as well as to accommodate work pieces 102 having different shapes or sizes. It will be recognized that, similar to the support arrangements, the drive mechanisms 112 can be interposed between machining stations 120A-H, or provided integrally therewith.

Representative drive mechanisms 112 are illustrated in U.S. Provisional Patent Application Ser. No. 61/074,077, filed Jun. 19, 2008, entitled “Material Feed Device,” the teachings and disclosure of which are incorporated herein in their entireties by reference thereto. As discussed therein, a plurality of drive mechanisms 112 can be connected together to synchronously drive the work piece 102 through the machining apparatus 100.

FIG. 1 represents one configuration of a machining apparatus according to the teachings of the present invention that includes nine (9) machining stations 120A-H. However, other embodiments can include more or less machining stations as well as machining stations in alternative arrangements.

Each machining station 120A-H can perform an independent machining operation on a work piece 102. Thus, in some implementations some of the machining stations may not be implemented or activated as a work piece passes along feed path 104 and is machined to a desired profile. For instance, only four independent surfaces may need to be machined on a work piece 102 eliminating the need to use five of the machining stations 120A-H.

The machining stations 120A-H are generally mounted to a frame structure 122 illustrated as a plurality of interconnected frame members 124. However in other embodiments the frame structure could be formed by a plurality of independent sections that are not interconnected. Further, the frame structure could take the form of parts of a building housing the machining apparatus such as the walls, roof/ceiling or floor of the building. Therefore, the frame structure can be formed by those structures that support the machining stations 120A-H. Such adjustment can be performed manually, or by using CNC methodologies.

The machining stations 120A-H of the illustrated embodiment are mounted for adjustability relative to the frame structure 122 such that the machining stations can be repositioned to adjust the type of machining that is performed, the location where machining is occurring on a work piece 102, as well as to accommodate work pieces 102 of various sizes.

The machining stations 120A-H are adjustable in two dimensions that are not generally parallel to feed path 104. More particularly, the machining stations 120A-H are adjustable in two dimensions that are generally perpendicular to feed path 104, as illustrated by arrows 126, 128. Typically, these two dimensions will permit the machining stations 120A-H to be positioned closer or further from the feed path 104 or alternatively laterally left and right relative to the feed path. While not illustrated in this embodiment, alternative embodiments may also allow for adjustment of the location of the machining stations 120A-H along the length of the feed path 104, such as in a direction illustrated by arrow 130. Additionally, some embodiments may allow for angularly rotating a machining station 120A-H, or at least a part of a machining station 120A-H, within a plane that is generally perpendicular to feed path 104. This can allow for machining independent surfaces at different angular orientations depending on a desired finished profile.

Further, and with primary reference to FIG. 3, some machining stations 120A-H may be aligned with another machining station 120A-H along feed path 104. Typically, but not always, in this aligned relationship, the two machine stations, such as machining stations 120F and 120E will be directly opposed to one another. In a more preferred arrangement, the axis of rotation about which machining heads of the machining station rotate are aligned with one another as well. This arrangement can help balance some of loading applied to the work piece 102 as a result of the machining operations. Aligning the machining heads results in the simultaneous machining of opposing surfaces of the work piece 102. In this arrangement, the machining heads of the machining stations 120E and 120F are on opposed sides of the work piece 102. Similarly, the machining heads of machining stations 120C and 120D are in opposed relation on opposed sides of work piece 102.

With primary reference to FIGS. 1 and 2 and machining station 120F for illustrative purposes, the machining stations 120A-H generally include a motor 134 that operably drive a machining head 136. In the illustrated embodiment, the motor 134 is operably coupled to the machining head 136 by a belt drive arrangement. The belt drive arrangement couples the output of the motor 134 to an input of a gear train 138. The machining head 136 is operably mounted to an output shaft of the gear train 138.

In preferred embodiments, the machining head 136 is removable from the gear train such that different machining heads 136 for forming different independent surfaces on the work piece 102 may used. Alternatively, different sized machining heads 136 may be used to accommodate machining different sized work pieces 102. Further yet, different types of machining heads may be used to perform different machining operations on the work piece 102.

Thus, it shall be apparent that the work piece 102 flows along the feed path 104 in the feed direction 130 through the machining apparatus 100 as it is machined. To maintain a high degree of dimensional accuracy, the machining stations 120A-H are maintained in a fixed relationship relative to the frame 122. As a result, the machining stations 120A-H are also in a fixed relationship to one another by being in fixed relation to the frame 122.

By having numerous independent machining stations 120A-H, the machining stations can be positioned relative to one another to locate corresponding surfaces defined by the various machining operations provided by the machining stations 120A-H.

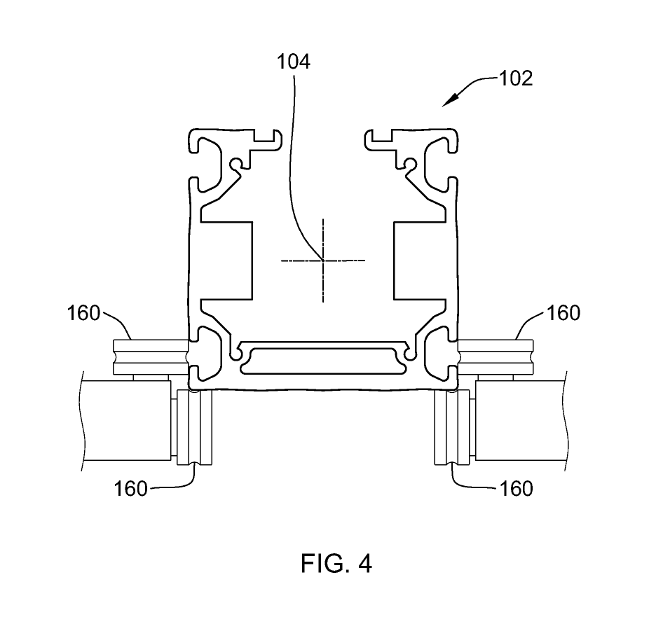

With reference to FIGS. 4-8, the machining steps of the machining apparatus and methods of machining according to embodiments of the present invention will be further described. FIG. 4 is an exaggerated end profile representation of a work piece 102 prior to passing through the machining apparatus 100. This work piece 102 is typically an elongated rail or bar that has been extruded or rough machined to the instant profile. Unfortunately, the applicants have determined that the rough extrusion or rough machining is not sufficient in applications necessitating high dimensional accuracy. One particular application would be using the work piece 102 for guiding carriages along a guide rail in linear actuation systems.

In such applications, the carriage guides along the surfaces of the guide rail. For the carriage to maintain an accurate and precise location through its travel along the rail, the surfaces of the guide rail the carriage contacts must have a high degree of dimensional accuracy. Therefore, the applicants have determined that it is desirous to further machine the work piece 102 to provide the desired degree of dimensional accuracy, i.e. tolerances, between various ones of the surfaces to provide for high tolerancing, particularly in the situations where the work piece is used as a guide.

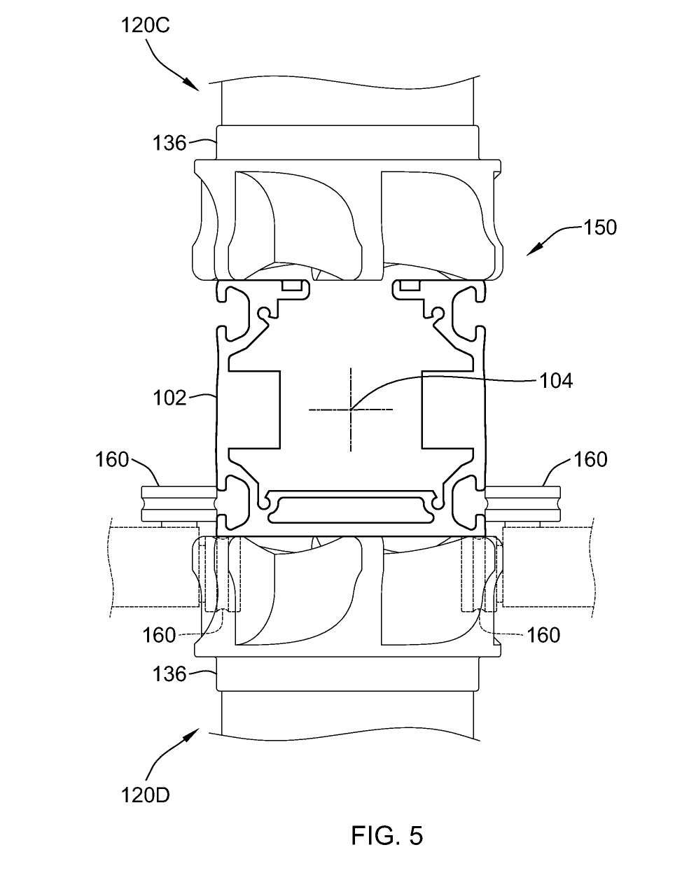

FIGS. 5-7 illustrate various phases of machining contemplated an embodiment of the invention. The result of these phases is a finished work piece 150, as illustrated in FIG. 8.

In the illustrated embodiment of FIG. 5, and with additional reference to FIG. 8, the work piece 102, in its raw unfinished condition, may be passed through machining stations 120C and 120D to simultaneously machine vertically opposing independent surfaces 152C, 152D. By simultaneously machining these two surfaces, the tolerance between them per linear foot of the finished machine work piece 150 is significantly improved. More particularly, tolerance of 0.025 inch of parallelism per linear foot along a length of finished machined work piece 150 may be obtained. More preferably, tolerance of 0.001 inch of parallelism per linear foot along a length of finished machined work piece 150 may be obtained.

In the illustrated embodiment of FIG. 6A, and with additional reference to FIG. 8, the work piece 102, passes through machining stations 120E and F to simultaneously machine horizontally opposing independent surfaces 152E, 152F. Again, similar tolerancing can be obtained for these surfaces as that for independent surfaces 152C, 152D.

As illustrated in FIG. 6A and discussed above, a pair of guide rollers 160 vertically guide and vertically bias the work piece 102 against other guide rollers 160 situated along the feed path 104. Also as discussed above, in an alternative embodiment illustrated in FIG. 6B, a single guide roller 160 can vertically bias the work piece 102 similar to that discussed above.

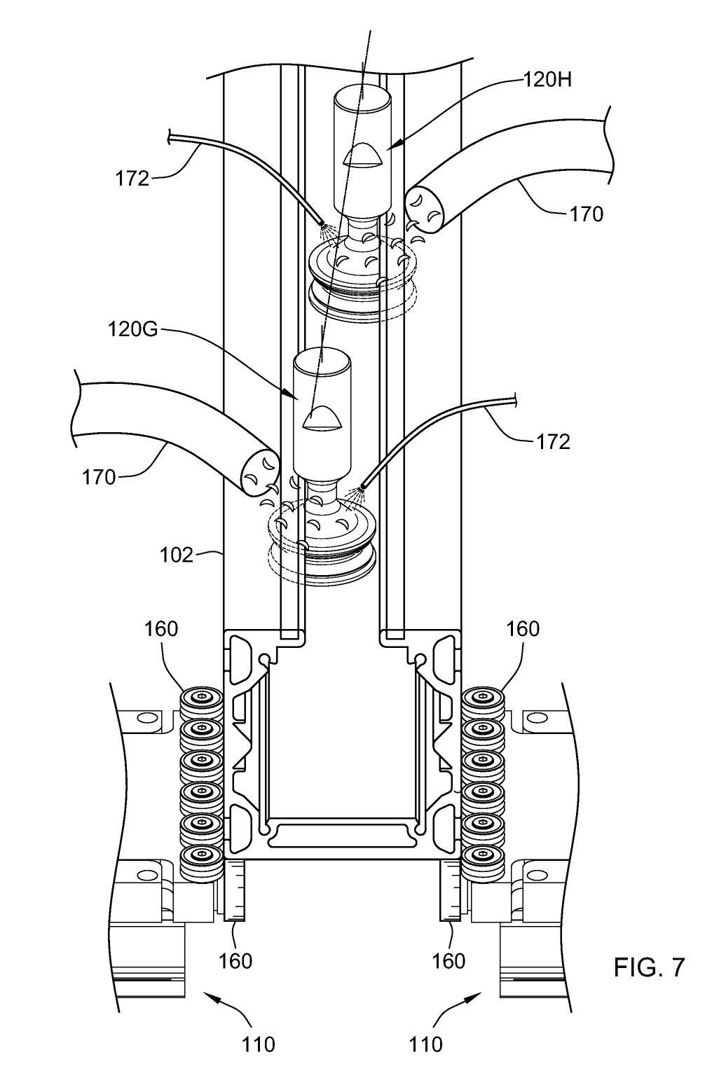

As illustrated in FIG. 7, and with additional reference to FIG. 8, the work piece then passes through machining stations 120G and 120H to machine horizontally opposed independent surfaces 152G and 152H. As illustrated in FIG. 7, the machining stations 120G and 120H are centrically aligned within a plane 121. This plane 121 can be oblique to the work piece 102, such that machining station 120G initially contacts the leading end of the work piece 102 prior to when machining station 120H initially contacts the leading end of the work piece 102. However, in other embodiments, the plane 121 can be generally normal to the work piece 102, such that the machining stations 120G and 120H contact the leading end of the work piece 102 simultaneously.

Because the outer surfaces 152C-152D have a high degree of dimensional accuracy, locating off of these surfaces will provide accuracy and precision relative thereto for independent surfaces 152G and 152H. This can be important for those situations where, for example, surface 152D is used to mount the work piece 150, when embodied as a guide rail, to another device and a carriage travels along and is guided by independent surfaces 152G and 152H.

It will be readily understood that the relationship between surface 152D and the mounting surface of the device will govern the overall carriage location. Put another way, surfaces 152G, 152H are machined after indicating from a qualified surface, e.g. surface 152D. As a result, these surfaces 152G, 152H possess a high degree of dimensional accuracy relative to their respective qualified surface, in this case surface 152D. As a further result, in applications where the work piece 150 is flush mounted against another device using surface 152D, the carriage will travel accurately along the work piece 150, embodied as a guide rail, and relative to the other device.

With reference to FIGS. 2 and 3, the guide rollers 160 of the vices 110 which support the work piece during machining can precisely locate the work piece 102 relative to the machining station 120A-H by contacting and acting on the previously machined qualified surfaces 152C-F.

FIG. 8 illustrates an example of one finished machined work piece 150 that could be formed by from work piece 102 by passing it through the machining apparatus 100 using methods according to embodiments of the present invention. In one method of machining the work piece 102, the finished machine work piece 150 has six independent surfaces 152C-152H that are formed into the finished work piece 150.

As used herein an “independent surface” is a surface that has been machined independently from other surfaces. An “independent surface” may be planar (see surface 152D), may be discontinuous (see surfaces 152C, 152E, 152F) and may have a contoured profile such that it is not a planar surface (see surfaces 152G, 152H). Clearly, independent surfaces 152G, 152H have multiple surface portions forming an independent surface that are all formed simultaneously, or in the alternative, using separate machining stations.

In the illustrated example, the outer independent surfaces 152C-152F may be used to mount the finished machined work piece 150 and the inner independent surfaces 152G and 152H may be used to mount hardened raceways or alternatively be used as raceways themselves. Such rail and raceway arrangements are illustrated in U.S. Patent Application Ser. No. 11/943,890, filed Nov. 21, 2007, and entitled “Bearing Assembly and Method of Making a Bearing Assembly,” the teachings and disclosures of which are incorporated herein by reference thereto. More particularly, embodiments of the instant invention can be used to, at least, machine the base rail disclosed therein. Additional examples where the apparatus and methods of the present invention can be used are illustrated in U.S. Provisional Patent Application Ser. No. 61/117,795, filed Nov. 25, 2008, entitled “Guide Rail Having Base Rail and Gear Rack, Method of Making Same, Guide Assembly Including Same,” the teachings and disclosures of which are incorporated herein by reference thereto.

Referring back to FIGS. 1-3, as the work piece 150 exits the linear arrangement of machining stations 120A-H, vices 110 and particularly guide rollers 160, of vices 110 laterally guide the work piece 102 along feed path 104. In this configuration, the work piece is laterally and vertically fixed and the lateral positioning of the work piece 102 is maintained and centered as the work piece 102 is machined. By having this arrangement, the parallelism tolerancing between the top and bottom independent surfaces 152C, 152D and the side independent surfaces 152E and 152F can be maintained at high levels as well, such as the parallelism of 0.025 inch per linear foot and more preferably 0.001 inch of parallelism per linear foot along the length of machined work piece 150.

Typically, a work piece 102 will be long enough such that multiple machining stations 120A-H will operate on the work piece 102 simultaneously. For example, as work piece 102 travels from left to right in FIG. 1, in one embodiment, the work piece 102 will be machined by machining operations provided by machining stations 120C-120H. Thus, in this arrangement, at least partially, machining of the work piece 102 will occur simultaneously as it passes along feed path 102. Further, additional ones of the machining stations 120A-H may operate on the work piece 102 at the same time. Even further, the machining stations 120A-H can machine the work piece 102 in a different order than that discussed above, depending upon the application.

Thus, the present apparatus 100 and methods provide for machining independent surfaces while locating the work piece 102 off of qualified surfaces. Further, as some independent surfaces are being formed simultaneously, either completely or partially, the numerous qualified surfaces can be formed relative to one another with only a single set-up significantly reducing potential for entry of reduction in tolerance between the various independent surfaces.

The feed arrangement may also include additional devices for maintaining the position of the work piece 102 along the feed path 104. With reference to FIG. 8, the machining apparatus includes a biasing mechanism, illustrated as a biased roller 160, for vertically biasing the work piece 102 against the rollers 160 of vices 110.

As illustrated in FIG. 1, the machining apparatus 100 includes an electronic controller 180. In one embodiment, the electronic controller 180 is operably coupled to positioning devices of the various machining stations 120A-H. The electronic controller 180 controls the positioning devices to automatically adjust the position of, at least, the machining heads 136 of the machining stations 120A-H. The positioning devices may include pneumatic, hydraulic, electric, and the like, actuators for positioning, at least, the machining heads 136. The electronic controller 180 is operably coupled to these actuators to control the positioning, at least, of the machining heads.

Further, the electronic controller 180 may include memory for storing pre-programmed machining configurations that include particular positioning and operating parameters for each of the machining stations such that the user can quickly switch the configuration of the machining apparatus 100 for differing profiles and sizes of work pieces 102. Not only can the controller 180 control the position of the machining stations 120A-H, the controller 180 can also control the operation of the machining stations 120A-H including the operating parameters driving the machining head including speed and torque. The controller 180 would also be operably coupled to positioning systems for the feed arrangements 112 and the vices 110 so that they are automatically adjusted upon switching of the machining configurations.

Referring back to FIG. 7, the machining apparatus 100 can also include a chip vacuum system. The vacuum system operates to remove chips generated during machining. The vacuum system supplants a more complex and costly chip auger/conveyer systems. The vacuum system includes a plurality of hoses 170. Each hose 170 is directed at a portion of the work piece 102 as it passes along the feed path 104. As illustrated in FIG. 7, certain ones of the hoses 170 can be directed proximate to the machining heads 136 of the machining stations.

Still referring to FIG. 7, the machining apparatus 100 can also include a coolant system. The coolant system includes a plurality of nozzles 172 that spray a mist of coolant over the machining heads 136. The coolant system is operably coupled to the controller such that the nozzles 172 spray an optimal amount of coolant on the machining heads 136. As a result, a more costly flood coolant system with associated pumps, drainage, and filtration elements is not required.

While it is desirable to have automatically adjustable machining stations, other embodiments, such as illustrated, include manually adjustable machining stations, feed arrangements and vices.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for machining a work piece comprising the steps of:
machining a first independent surface into the work piece along a length of the work piece using a first machining station; and
machining a second independent surface into the work piece along the length of the work piece using a second machining station.

2. The method of claim 1, further comprising the step of:
feeding the work piece along a feed path relative to the first and second machining stations while maintaining the first and second machining stations stationary relative to a frame supporting the first and second machining stations.

3. The method of claim 2, wherein the step of machining the first independent surface is performed at a location upstream along the feed path relative to the step of machining the second independent surface.

4. The method of claim 2, wherein the step of machining the first independent surface is performed at a same location along the feed path relative to the step of machining the second independent surface, such that the steps of machining the first and the second independent surfaces are completed simultaneously.

5. The method of claim 4, wherein the steps of machining the first and second independent surfaces are conducted simultaneously wherein the first and second machine stations are in opposed axial alignment, such that the first and second independent surfaces are in opposed spaced relation and parallel to one another.

6. The method of claim 3, wherein the step of machining the first independent surface defines a first qualified surface and the second independent surface is toleranced relative to the first qualified surface.

7. The method of claim 6, further comprising the step of supporting the work piece at the first qualified surface in a direction transverse at the location where the step of machining the second independent surface is performed on the work piece such that the second independent surface is machined relative to the first qualified surface and is toleranced therefrom.

8. The method of claim 2, wherein the step of machining the first independent surface defines a first qualified surface and the second independent surface is toleranced relative to the first qualified surface, further comprising the steps of machining a third independent surface into the work piece along the length of the work piece using a third machining station and machining a fourth independent surface into the work piece along the length of the work piece using a fourth machining station, wherein the step of machining the third independent surface defines a second qualified surface and the fourth independent surface is toleranced relative to the second qualified surface.

9. The method of claim 8, further comprising the step of supporting the work piece in a first direction transverse to the length of the feed path with the first qualified surface at the location where the step of machining the second independent surface is performed on the work piece and further comprising the step of supporting the work piece in a second direction transverse to the length of the feed path with the second qualified surface at the location where the step of machining the fourth independent surface is performed on the work piece such that the fourth independent surface is machined relative to the second qualified surface and is toleranced therefrom.

10. The method of claim 2, further comprising the step of adjusting a position of at least one of the first and second machining stations relative to the feed path in a direction not parallel to the feed path, prior to machining of the work piece; and wherein the step of adjusting the position of at least one of the first and second machining stations includes adjusting an angular position of the at least one first and second machining stations about the feed path.

11. The method of claim 10, wherein the step of adjusting the position of at least one of the first and second machining stations adjusts the angular position of the at least one first and second machining station about the feed path as well as adjusts the position of the at least one first and second machining stations relative to the other one of the first and second machining stations.

12. The method of claim 2, further comprising the step of adjusting a position of at least one of the first and second machining stations relative to the feed path in a direction not parallel to the feed path, prior to machining of the work piece, wherein the step of adjusting the position of at least one of the first and second machining stations includes moving the machining station linearly along a direction that is oblique to the direction of travel along which the work piece travels along the feed path.

13. The method of claim 2, further comprising the step of adjusting a position of at least one of the first and second machining stations relative to the feed path in a direction not parallel to the feed path, prior to machining of the work piece, wherein the step of adjusting a position of at least one of the first and second machining stations includes switching to one of a plurality of predetermined configurations of the first and second machining stations relative to the feed path.

14. The method of claim 2, further comprising the steps of machining a third independent surface into the work piece along the length of the work piece using a third machining station and machining a fourth independent surface into the work piece along the length of the work piece using a fourth machining station; and
further comprising the step of locating the work piece using the first and second independent surfaces during at least one of the steps of machining the third and fourth independent surfaces.

15. The method of claim 14, wherein the at least one of the steps of machining the third and fourth independent surfaces occurs downstream from the steps of machining the first and second independent surfaces.

16. The method of claim 1, wherein the step of feeding includes feeding the work piece using a feed arrangement, the feed arrangement having at least one support arrangement and at least one drive mechanism, wherein the support arrangement contacts at least one of the first and second independent surfaces.

17. The method of claim 1, wherein the step of feeding includes feeding the work piece using a feed arrangement, the feed arrangement having at least one support arrangement and at least one drive mechanism;
wherein the support arrangement contacts at least one of the first and second independent surfaces, wherein the at least one support arrangement includes a plurality of rollers in contact with the work piece; and
wherein the at least one drive mechanism includes a first and a second drive mechanism, the first and second drive mechanisms operably coupled together to synchronously feed the work piece during the step of feeding.

18. The method of claim 17, further comprising the steps of:
machining a third independent surface into the work piece along the length of the work piece using a third machining station;
machining a fourth independent surface into the work piece along the length of the work piece using a fourth machining station;
wherein the steps of machining the third and fourth independent surfaces are performed simultaneously at a same location along the feed path and at least one of the third and fourth independent surface is a second qualified surface; and
wherein the steps of machining the first and second independent surfaces are performed at a location upstream along the feed path from a location where the steps of machining the third and fourth independent surfaces.

19. The method of claim 17, further comprising the steps of:
machining a third independent surface into the work piece along the length of the work piece using a third machining station;
machining a fourth independent surface into the work piece along the length of the work piece using a fourth machining station;
wherein the steps of machining the third and fourth independent surfaces are performed simultaneously at a same location along the feed path and at least one of the third and fourth independent surface is a second qualified surface; and
wherein the first, second, third and fourth surfaces are qualified surfaces.

20. The method of claim 17, further comprising the steps of:
machining a third independent surface into the work piece along the length of the work piece using a third machining station;
machining a fourth independent surface into the work piece along the length of the work piece using a fourth machining station;
wherein the steps of machining the third and fourth independent surfaces are performed simultaneously at a same location along the feed path and at least one of the third and fourth independent surface is a second qualified surface; and
further comprising locating the steps of machining at least one of the third and fourth independent surfaces off of the first qualified surface.

21. The method of claim 17, further comprising the steps of:
machining a third independent surface into the work piece along the length of the work piece using a third machining station;
machining a fourth independent surface into the work piece along the length of the work piece using a fourth machining station;
wherein the steps of machining the third and fourth independent surfaces are performed simultaneously at a same location along the feed path and at least one of the third and fourth independent surface is a second qualified surface; and
further comprising the steps of:
machining a fifth independent surface into the work piece along the length of the work piece using a fifth machining station; and
locating the step of machining the fifth surface off of the first qualified surface.

22. The method of claim 1, wherein the first and second independent surfaces have a parallelism of between about 0.001 to 0.0025 inch per foot.

23. The method of claim 2, wherein all independent surfaces are formed by a single pass of the work piece along the feed path.

24. An apparatus for machining work piece comprising:
a frame;
a first machining station for machining a first independent surface into the work piece, the first machining station mounted to the frame;
a second machining station for machining a second independent surface into the work piece, the second machining station mounted to the frame; and
a feed arrangement for feeding the work piece through the apparatus along a feed path and relative to the first and second machining stations and the frame while machining is performed on the work piece.

25. The apparatus of claim 24, further comprising a third, fourth, fifth and sixth machining stations mounted to the frame for machining third, fourth, fifth and sixth independent surfaces into the work piece, respectively.

26. The apparatus of claim 24, wherein the first and second machining stations are moveable relative to the frame to adjust positions thereof relative to the feed path, the first and second machining stations being fixed in various positions during machining; and
wherein the first and second machining stations are moveable relative to the frame such that the first and second machining stations are angularly positionable relative to the feed path.

27. The apparatus of claim 24, wherein the first and second machining stations are moveable relative to the frame to adjust positions thereof relative to the feed path, the first and second machining stations being fixed in various positions during machining; and
wherein the first and second machining stations are moveable relative to the frame such that the first and second machining stations are linearly positionable relative to the feed path along a direction that is perpendicular to the feed path.

28. The apparatus of claim 24, wherein the first machining station is positioned upstream from the second machining station along the feed path.

29. The apparatus of claim 24, wherein the feed arrangement includes a plurality of drive mechanisms, the plurality of drive mechanisms operably connected to one another to synchronously drive the work piece along the feed path.

30. The apparatus of claim 24, wherein the first and second machining stations includes a motor, a machining head and a positioning system, the motor operably coupled to the machining head to drive the machining head to perform a machining operation, the positioning system mounting, at least, the machining head to the frame and adjusting the position of the machining head relative to the frame.

31. The apparatus of claim 24, wherein the first and second machining stations are stationary relative to the frame during machining and work piece is fed linearly along the feed path through the apparatus during machining, the first and second machining stations serially aligned relative to the feed path.

32. The apparatus of claim 28, wherein the feed arrangement includes an upstream portion upstream along the feed path from the first machining station and a downstream portion downstream along the feed path from the first machining station, wherein the downstream portion includes a first support arrangement, the first support arrangement supporting the work piece via the first independent surface after the work piece passes through and is machined by the first machining arrangement; and
wherein the first support arrangement includes a first guide upon which the first independent surface rides, the first support arrangement further including a biasing mechanism for biasing the work piece toward the first guide and the first independent surface into the first guide.

33. The apparatus of claim 24, wherein the first and second machining stations are axially aligned in an opposed spaced relationship such that the first and second machining stations form the first and second independent surfaces simultaneously, the first and second surfaces being parallel to one another.

34. The apparatus of claim 28, wherein the feed arrangement includes an upstream portion upstream along the feed path from the first machining station and a downstream portion downstream along the feed path from the first machining station, wherein the downstream portion includes a first support arrangement, the first support arrangement supporting the work piece via the first independent surface after the work piece passes through and is machined by the first machining arrangement; and
wherein the feed arrangement includes a second downstream portion downstream along the feed path from the second machining station, wherein the second downstream portion includes a second support arrangement, the second support arrangement supporting the work piece via the second independent surface after the work piece passes through and is machined by the second machining station.

35. The apparatus of claim 28, wherein the feed arrangement includes an upstream portion upstream along the feed path from the first machining station and a downstream portion downstream along the feed path from the first machining station, wherein the downstream portion includes a first support arrangement, the first support arrangement supporting the work piece via the first independent surface after the work piece passes through and is machined by the first machining arrangement; and
further comprising a third machining station for machining a third independent surface into the work piece, the third machining station being downstream from the first machining station, the positioning of the third machining station being toleranced relative to the first machining station.

36. The apparatus of claim 24, further comprising an electronic controller for controlling operations of the first and second machining stations;
wherein the electronic controller is preprogrammed with a plurality of different selectable machining station set-ups for machining different profiles into the work piece; and
wherein a difference between at least two of the different machining station set-ups is a position of at least one of the first and second machining stations relative to the feed path, the electronic controller operably controlling the position of the first and second machining stations in accordance with the selected one of the selectable machining station set-ups.
